(19) United States
(12) Patent Application Publication
(10) Pub. No.: US 2016/0100277 A1
(43) Pub. Date: Apr. 7, 2016

(54) SECONDARY RADIO FUNCTIONALITY INTEGRATION IN A VEHICLE

(71) Applicant: VOXX INTERNATIONAL CORPORATION, Hauppauge, NY (US)

(72) Inventors: Laszlo Barabas, Palos Verdes Peninsula, CA (US); Alfred Barabas, La Habra, CA (US)

(21) Appl. No.: 14/547,846

(22) Filed: Nov. 19, 2014

Related U.S. Application Data
(60) Provisional application No. 62/060,191, filed on Oct. 6, 2014.

(51) Int. Cl. H04W 4/00; H04W 76/02

(52) U.S. Cl. CPC H04W 4/008; H04W 76/02

(57) ABSTRACT

A method of integrating secondary radio functionality in a vehicle includes establishing a wired connection between a secondary radio receiver integration unit and a secondary radio receiver unit, establishing a wireless connection between the secondary radio receiver integration unit and a vehicle receiver unit mounted in the vehicle, transmitting audio data from the secondary radio receiver unit to the secondary radio receiver integration unit via the wired connection, and transmitting the audio data from the secondary radio receiver integration unit to the vehicle receiver unit via a wireless connection. The audio data is played via a speaker connected to the vehicle receiver unit.

### CROSS-REFERENCE TO RELATED APPLICATIONS

This application claims priority to and the benefit of Provisional Application Ser. No. 62/060,191, filed on Oct. 6, 2014, the disclosure of which is herein incorporated by reference in its entirety.

### BACKGROUND

1. Technical Field

Exemplary embodiments of the present invention relate to integrating secondary radio functionality in a vehicle, and more particularly, to a system and method of integrating secondary radio functionality in a vehicle that does not otherwise have such secondary radio functionality.

2. Discussion of Related Art

Many vehicles do not include certain types of secondary radio functionality pre-installed in the vehicle. For example, many vehicles do not include a built-in satellite radio receiver unit. Although third party manufactures offer secondary radio receiver units (e.g., aftermarket satellite radio receiver units) that can be added to vehicles that are not sold with such secondary radio functionality (e.g., satellite radio functionality) pre-installed, some vehicles may not allow for the connection of such secondary radio receiver units. This may be due to the vehicle not having the proper physical connection port (e.g., DIN port) available to connect a secondary radio receiver unit thereto, and/or not having the proper software support in the vehicle's existing receiver unit (e.g., the vehicle's built-in stereo/radio receiver unit) to interface with a secondary radio receiver unit.

### SUMMARY

According to an exemplary embodiment of the present invention, a method of integrating secondary radio functionality in a vehicle includes establishing a wired connection between a secondary radio receiver integration unit and a secondary radio receiver unit, establishing a wireless connection between the secondary radio receiver integration unit and a vehicle receiver unit mounted in the vehicle, transmitting audio data from the secondary radio receiver unit to the secondary radio receiver integration unit via the wired connection, and transmitting the audio data from the secondary radio receiver integration unit to the vehicle receiver unit via a wireless connection. The audio data is played via a speaker connected to the vehicle receiver unit.

In an exemplary embodiment, the method includes receiving visual content generated by the secondary radio receiver unit at the secondary radio receiver integration unit via the wired connection, and transmitting the visual content from the secondary radio receiver integration unit to the vehicle receiver unit via the wireless connection. The visual content is displayed via a display connected to the vehicle receiver unit. The display may be built into the vehicle receiver unit.

In an exemplary embodiment, the method includes receiving a control command at the secondary radio receiver integration unit via the wireless connection. The control command is issued by the vehicle receiver unit in response to a user interacting with the vehicle receiver unit. The method further includes transmitting the control command from the secondary radio receiver integration unit to the secondary radio receiver unit via the wired connection. The control command is executed at the secondary radio receiver unit to perform a function corresponding to the control command at the secondary radio receiver unit.

In an exemplary embodiment, the visual content is mapped, by the secondary radio receiver integration unit, from a first format decipherable by the secondary radio receiver unit to a second format that is different from the first format and is decipherable by the vehicle receiver unit, and the visual content is transmitted from the secondary radio receiver integration unit to the vehicle receiver unit in the second format.

In an exemplary embodiment, the wireless connection is a BLUETOOTH connection, the audio data is transmitted using an Advanced Audio Distribution Profile (A2DP) BLUETOOTH profile, and the visual content is mapped using an Audio/Video Remote Control Profile (AVRCP) BLUETOOTH profile. The AVRCP BLUETOOTH profile may be version 1.4 or higher.

In an exemplary embodiment, the control command is mapped, by the secondary radio receiver integration unit, from a first format decipherable by the vehicle receiver unit to a second format that is different from the first format and is decipherable by the secondary radio receiver unit, and the control command is relayed from the secondary radio receiver integration unit to the secondary radio receiver unit in the second format.

In an exemplary embodiment, the wireless connection is a BLUETOOTH connection, the audio data is transmitted using an Advanced Audio Distribution Profile (A2DP) BLUETOOTH profile, and the control command is mapped using an Audio/Video Remote Control Profile (AVRCP) BLUETOOTH profile. The AVRCP BLUETOOTH profile may be version 1.4 or higher.

In an exemplary embodiment, the vehicle receiver unit is non-removably mounted in the vehicle, for example, in a dashboard of the vehicle.

According to an exemplary embodiment of the present invention, a method of integrating satellite radio functionality in a vehicle includes establishing a wired connection between a satellite radio receiver integration unit and an aftermarket satellite radio receiver unit, and establishing a BLUETOOTH connection between the satellite radio receiver integration unit and a vehicle receiver unit non-removably mounted in the vehicle. The aftermarket satellite radio receiver unit and the vehicle receiver unit are not directly connected to each other. The method further includes transmitting audio data from the aftermarket satellite radio receiver unit to the satellite radio receiver integration unit via the wired connection, and transmitting the audio data from the satellite radio receiver integration unit to the vehicle receiver unit via the BLUETOOTH connection. The audio data is played via a speaker connected to the vehicle receiver unit.

According to an exemplary embodiment of the present invention, a secondary radio receiver integration unit includes a processor configured to process audio data, a data connection interface configured to connect the secondary radio receiver integration unit to an secondary radio receiver unit via a wired connection, and a wireless transceiver configured to connect the secondary radio receiver integration unit to a vehicle receiver unit mounted in the vehicle via a wireless connection. The data connection interface is configured to transmit the audio data from the secondary radio receiver unit to the secondary radio receiver integration unit, and the wireless transceiver is configured to transmit the audio data from the secondary radio receiver integration unit to the vehicle receiver unit to be played via a speaker connected to the vehicle receiver unit.

In an exemplary embodiment, the data connection interface is further configured to receive visual content generated by the secondary radio receiver unit, and the wireless transceiver is further configured to transmit the visual content from the secondary radio receiver integration unit to the vehicle receiver unit to be displayed via a display connected to the vehicle receiver unit. The display may be built into the vehicle receiver unit.

In an exemplary embodiment, the wireless transceiver is a BLUETOOTH transceiver, the BLUETOOTH transceiver is configured to receive a control command issued by the vehicle receiver unit in response to a user interacting with the vehicle receiver unit, and the data connection interface is configured to transmit the control command from the secondary radio receiver integration unit to the secondary radio receiver unit to execute the control command at the secondary radio receiver unit to perform a function corresponding to the control command at the secondary radio receiver unit. The processor is configured to map the visual content from a first format decipherable by the secondary radio receiver unit to a second format that is different from the first format and is decipherable by the vehicle receiver unit, and the visual content is relayed from the secondary radio receiver integration unit to the vehicle receiver unit in the second format. The audio data is transmitted using an Advanced Audio Distribution Profile (A2DP) BLUETOOTH profile, and the visual content is mapped using an Audio/Video Remote Control Profile (AVRCP) BLUETOOTH profile.

In an exemplary embodiment, the wireless transceiver is a BLUETOOTH transceiver, the BLUETOOTH transceiver is configured to receive a control command issued by the vehicle receiver unit in response to a user interacting with the vehicle receiver unit, and the data connection interface is configured to transmit the control command from the secondary radio receiver integration unit to the secondary radio receiver unit to execute the control command at the secondary radio receiver unit to perform a function corresponding to the control command at the secondary radio receiver unit. The processor is configured to map the control command from a first format decipherable by the vehicle receiver unit to a second format that is different from the first format and is decipherable by the secondary radio receiver unit, and the control command is transmitted from the secondary radio receiver integration unit to the secondary radio receiver unit in the second format. The audio data is transmitted and relayed using an Advanced Audio Distribution Profile (A2DP) BLUETOOTH profile, and the control command is mapped using an Audio/Video Remote Control Profile (AVRCP) BLUETOOTH profile.

In an exemplary embodiment, the secondary radio receiver unit is an aftermarket satellite radio receiver unit and the secondary radio receiver integration unit is a satellite radio receiver integration unit.

In an exemplary embodiment, the vehicle receiver unit is non-removably mounted in a dashboard of the vehicle.

### BRIEF DESCRIPTION OF THE DRAWINGS

The above and other features of the present invention will become more apparent by describing in detail exemplary embodiments thereof with reference to the accompanying drawings, in which:

FIG. 1 shows an overview of integrating secondary radio functionality in a vehicle according to an exemplary embodiment of the present invention.

FIG. 2 is a block diagram showing a secondary radio receiver integration unit according to an exemplary embodiment of the present invention.

FIG. 3 is a flowchart showing a method of integrating secondary radio functionality in a vehicle according to an exemplary embodiment of the present invention.

FIG. 4 shows an example of a virtual menu system utilized when mapping data between a secondary radio receiver unit and an existing vehicle receiver unit according to an exemplary embodiment of the present invention.

FIG. 5 illustrates a computer system for implementing aspects of exemplary embodiments of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to like elements throughout the accompanying drawings.

Exemplary embodiments of the present invention provide a system and method of integrating secondary radio functionality (e.g., satellite radio functionality) into a vehicle that may not otherwise support such secondary radio functionality (e.g., satellite radio functionality). For example, certain vehicles may not include a built-in satellite radio receiver, and further, may not allow for the connection of an aftermarket satellite radio receiver unit to the vehicle's existing receiver unit (e.g., the vehicle's built-in stereo/radio receiver unit). This may be due to the vehicle not having the proper physical connection port available to connect an aftermarket satellite radio receiver unit thereto, and/or not having the proper software support in the vehicle's existing receiver unit to interface with an aftermarket satellite radio receiver unit. Exemplary embodiments of the present invention allow for an aftermarket satellite radio receiver unit to be integrated into such a vehicle using, for example, a wireless connection such as a BLUETOOTH connection in combination with certain BLUETOOTH profiles (e.g., Audio/Video Remote Control Profile (AVRCP) and Advanced Audio Distribution Profile (A2DP) BLUETOOTH profiles).

It is to be understood that exemplary embodiments of the present invention are not limited to integration of satellite radio functionality. For example, exemplary embodiments of the present invention provide a secondary radio receiver integration unit configured to interface an existing vehicle receiver unit mounted in a vehicle with a secondary radio receiver unit via a wireless connection. The wireless connection may be, for example, a BLUETOOTH connection, or other types of wireless connections such as, for example, a Wi-Fi connection. The secondary radio receiver integration unit is utilized to integrate a certain type of radio functionality into a vehicle that does not otherwise include that type of radio functionality. For example, the secondary radio functionality may be, but is not limited to, satellite radio functionality, as described above, digital audio broadcasting (DAB) technology, etc. That is, according to an exemplary embodiment, the secondary radio receiver integration unit may be a satellite radio receiver integration unit, and may be utilized to integrate satellite radio functionality (e.g., using an aftermarket satellite radio receiver unit) into a vehicle having an existing radio receiver unit that does not otherwise include satellite radio functionality.

Herein, the term secondary radio receiver unit refers to any radio receiver unit that is not built into a vehicle by the vehicle's manufacturer, and that is designed to be added to an existing vehicle by interfacing with the vehicle's existing built-in receiver unit. Such secondary radio receiver units are typically small, portable units that connect to the existing vehicle receiver unit. The term existing vehicle receiver unit refers to a receiver unit semi-permanently mounted in a vehicle, for example, in the dashboard of the vehicle. The existing vehicle receiver unit may also be referred to herein as a stock vehicle receiver unit or a vehicle head unit. The term semi-permanently mounted refers to the existing vehicle receiver unit not being detachably mounted in the vehicle. For example, although the semi-permanently mounted vehicle receiver unit may be removed from the vehicle with the proper tools, the unit is not typically mounted in the vehicle via quick release latches, buttons, docking stations, etc., and thus, may not be quickly and conveniently removed from the vehicle by a user.

Exemplary embodiments described herein are not limited to being utilized in any particular make or model vehicle. Further, although exemplary embodiments may be described herein as being utilized to integrate SIRIUSXM satellite radio functionality into a vehicle, when the secondary radio receiver integration unit is a satellite radio receiver integration unit, the type of satellite radio functionality is not limited to SIRIUSXM satellite radio.

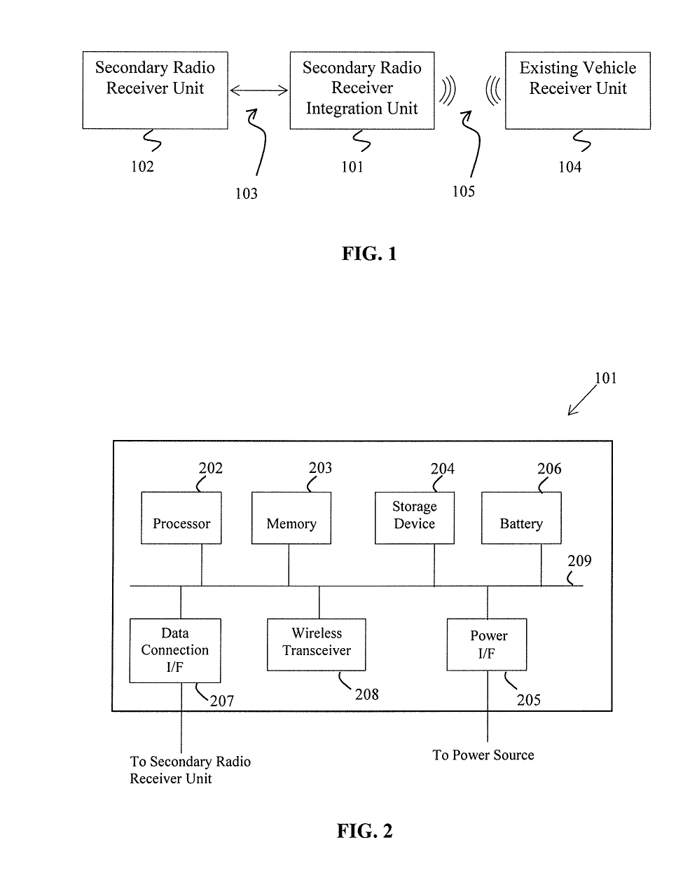

FIG. 1 shows an overview of integrating secondary radio functionality in a vehicle according to an exemplary embodiment of the present invention.

As shown in FIG. 1, a secondary radio receiver integration unit 101 (e.g., a satellite radio receiver integration unit) connects to a secondary radio receiver unit 102 (e.g., an aftermarket radio receiver unit such as, for example, an aftermarket satellite radio receiver unit) via a wired connection 103. The secondary radio receiver integration unit 101 further connects to an existing vehicle receiver unit 104 via a wireless connection 105 (e.g., via a BLUETOOTH connection). Once the secondary radio receiver integration unit 101 is connected to both the secondary radio receiver unit 102 and the existing vehicle receiver unit 104, the secondary radio receiver integration unit 101 facilitates communication between the secondary radio receiver unit 102 and the existing vehicle receiver unit 104, as described in further detail below. The secondary radio receiver unit 102 and the existing vehicle receiver unit 104 are not directly connected to each other (e.g., the units are not directly connected to each other via a direct wired connection or a direct wireless connection).

FIG. 2 is a block diagram showing a secondary radio receiver integration unit according to an exemplary embodiment of the present invention.

The secondary radio receiver integration unit 101 may be, for example, a stand-alone unit including, for example, a processor 202, a memory 203, a storage device 204, a power connection interface 205 (e.g., a 12V connection port to receive power from the vehicle), a battery 206, a data connection interface 207, and a wireless transceiver 208 (e.g., a Bluetooth transceiver). The components of the secondary radio receiver integration unit 201 communicate with each other via a bus(es) 209. It is to be understood that the secondary radio receiver integration unit 201 may include some or all of the components described with reference to FIG. 1, and may further include additional components. The secondary radio receiver integration unit 101 may also be referred to herein as a secondary radio receiver integration dongle.

The processor 202, memory 203 and storage device 204 are utilized to implement an integration and mapping program designed to facilitate two-way communication between the secondary radio receiver unit 102 and the existing vehicle receiver unit 104, as described below.

The power interface 205 is utilized to supply the secondary radio receiver integration unit 101 with power. The power interface 205 may be, for example, a 12V connection port configured to receive power from the vehicle. The secondary radio receiver integration unit 101 may also include a battery 206 to supply the unit 101 with power when the unit 101 is not connected to an external power source (e.g., the vehicle's power source). Exemplary embodiments may include both the power interface 205 and the battery 206, or one of the power interface 205 and the battery 206.

The data connection interface 107 is utilized to physically connect the secondary radio receiver integration unit 101 to the secondary radio receiver unit 102. For example, a data cable of the secondary radio receiver unit 102 may be plugged into the data connection interface 207. Once connected, data may be communicated between the secondary radio receiver integration unit 101 and the secondary radio receiver unit 102 via the wired connection 103. For example, the secondary radio receiver unit 102 may be controlled via commands transmitted thereto from the secondary radio receiver integration unit 101 via the data connection interface 207. The data connection interface 207 may utilize a variety of different interfaces to connect to the secondary radio receiver unit 102. For example, since many secondary radio receiver units 102 include a DIN connector designed to be plugged into a DIN port of a vehicle's existing radio unit, the data connection interface 207 may be a DIN interface capable of receiving a DIN connector (e.g., the DIN connector of the secondary radio receiver unit 102). However, the data connection interface 207 is not limited thereto and may include, for example, a proprietary connector. The wireless transceiver 208 is configured to establish a wireless connection between the secondary radio receiver integration unit 101 and the existing vehicle receiver unit 104. For example, many vehicles include an existing vehicle receiver unit 104 that supports BLUETOOTH. This BLUETOOTH support may be utilized to connect the existing vehicle receiver unit 104 to the secondary radio receiver integration unit 101. Once connected, data (e.g., audio data, visual data content, control commands, etc.) may be communicated between the existing vehicle receiver unit 104 and the secondary radio receiver integration unit 101 via the wireless (e.g., BLUETOOTH) connection 105.

Once the secondary radio receiver integration unit 101 has established a wired connection 103 with the secondary radio receiver unit 102 and a wireless connection 105 with the existing vehicle receiver unit 104, the secondary radio receiver integration unit 101 may facilitate communication between the secondary radio receiver unit 102 and the existing vehicle receiver unit 104 by allowing data to be transmitted and received between the secondary radio receiver unit 102 and the existing vehicle receiver unit 104 through the secondary radio receiver integration unit 104.

When the wireless connection is a BLUETOOTH connection, the secondary radio receiver integration unit 101 may be utilized in any vehicle having an existing vehicle receiver unit 104 that supports BLUETOOTH communication. Exemplary embodiments of the secondary radio receiver integration unit 101 may be described herein as being used in a vehicle having an existing vehicle receiver unit 104 that supports the Advanced Audio Distribution Profile (A2DP) and the Audio/Video Remote Control Profile (AVRCP) version 1.4. Herein, when an exemplary embodiment is described as using AVRCP version 1.4, it is to be understood that AVRCP 1.4 or any version higher than version 1.4 may be used. In addition, other versions of AVRCP may also be utilized, however, use of certain older versions may provide limited control functionality to the user. For example, use of certain older versions of AVRCP together with A2DP may allow for audio streaming from the secondary radio receiver unit 102 to the existing vehicle receiver unit 104, however, certain older versions may not allow the user to implement certain extended functionality (e.g., browsing functionality) of the secondary radio receiver unit 102 using the existing vehicle receiver unit 104, or may provide limited control of the secondary radio receiver unit 102 using the existing vehicle receiver unit 104 compared to when AVRCP 1.4 or higher is used. Thus, it is to be understood that although exemplary embodiments may be described herein as utilizing AVRCP 1.4 (or higher), certain exemplary embodiments may also utilize previous versions of AVRCP.

Utilization of the secondary radio receiver integration unit 101 with an existing vehicle receiver unit 104 that supports both A2DP and AVRCP 1.4 provides for a secondary radio integration approach having extended functionality. For example, the user may implement a variety of control functions to control the secondary radio receiver unit 102 via the existing vehicle receiver unit 104 when both A2DP and AVRCP 1.4 are supported. Exemplary embodiments may also be utilized with an existing vehicle receiver unit 104 that does not support AVRCP 1.4, however such an implementation provides a more limited level of functionality for the user, as described above. For example, in such a configuration, the user may be able to listen to audio originating from the secondary radio receiver unit 102, but the amount of control functions allowing the user to control the secondary radio receiver unit 102 using the existing vehicle receiver unit 104 may be more limited.

Referring to the A2DP and AVRCP Bluetooth profiles, A2DP defines the manner in which audio data is streamed from one device to another device via a BLUETOOTH connection. AVRCP, which may be used in conjunction with A2DP, provides a standard interface to control one device from another device via a BLUETOOTH connection. Using AVRCP 1.4, a user may use one device to control a variety of functions of another device including, for example, browsing and searching for content. A2DP and AVRCP are both standardized BLUETOOTH profiles.

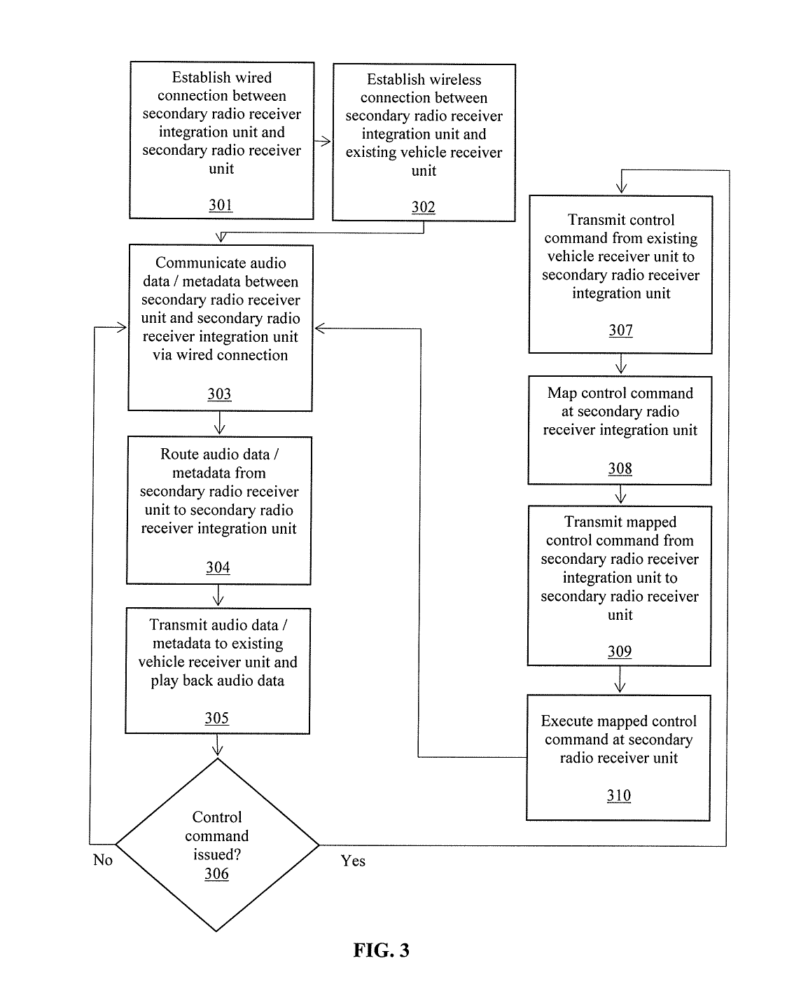

FIG. 3 is a flowchart showing a method of integrating secondary radio functionality in a vehicle according to an exemplary embodiment of the present invention.

Referring to FIG. 3, a first connection (e.g., wired connection 103) is established between the secondary radio receiver integration unit 101 and the secondary radio receiver unit 102 at block 301, and a second connection (e.g., wireless/BLUETOOTH connection 105) is established between the secondary radio receiver integration unit 101 and the existing vehicle receiver unit 104 at block 302. At block 303, audio data and metadata are communicated between the secondary radio receiver unit 102 and the secondary radio receiver integration unit 101. Metadata may include, for example, visual content (e.g., program information such as, for example, channel and category information) generated by the secondary radio receiver unit 102, as described in further detail below. In an exemplary embodiment (e.g., an exemplary embodiment that does not utilize AVRCP), audio data may be communicated without metadata throughout FIG. 3. The communication of audio data and metadata at block 303 may occur either before or after establishing the wireless connection at block 302. Once the first and second connections have been established, the audio data and metadata may be routed/transmitted from the secondary radio receiver unit 102 to the secondary radio receiver integration unit 101 via the first connection (e.g., wired connection 103) at block 304. The terms routed and transmitted may be used interchangeably herein, and refer to data (e.g., audio data, metadata, visual content, etc.) being passed from one device/component to another device/component. Once received by the secondary radio receiver integration unit 101, the audio data and metadata is relayed (e.g., received and passed on) to the existing vehicle receiver unit 104 by the secondary radio receiver integration unit 101 via the second connection (e.g., wireless/BLUETOOTH connection 105) for playback at the existing vehicle receiver unit 104 at block 305. That is, the audio data is transmitted from the secondary radio receiver integration unit 101 to the existing vehicle receiver unit 104 for playback at the existing vehicle receiver unit 104. The audio data may be buffered at the secondary radio receiver integration unit 101. Playback of the audio data at the existing vehicle receiver unit 104 may be implemented using, for example, a speaker(s) connected to the existing vehicle receiver unit 104 (e.g., a speaker(s) mounted in the vehicle). Visual content included in the communicated metadata may be displayed at the existing vehicle receiver unit 104 (e.g., via a display built into or connected to the existing vehicle receiver unit 104). Herein, visual content refers to any type of content that may be viewed by a user, as opposed to heard by a user. Examples of visual content include, but are not limited to, satellite radio channel information (e.g., channel names and numbers), artist information, song information, album information, genre information, satellite radio diagnostic information, etc.

At block 306, it is determined whether a control command has been issued by the existing vehicle receiver unit 104. A control command is issued in response to the user interacting with the existing vehicle receiver unit 104. The user may interact with the existing vehicle receiver unit 104 by interacting with an input control(s) of the existing vehicle receiver unit 104 such as, for example, a button, knob, touchscreen interface, remote control, etc. of the existing vehicle receiver unit 104. A control command may, for example, cause at least one of a variety of functions to be performed by the secondary radio receiver unit 102. For example, a control command may include, but is not limited to, a change channel command, a search command, a browse command, a rewind command, a fast forward command, a previous track command, a next track command, an information request command, etc.

If a control command is not issued at block 306, transmission and relaying of the audio data and metadata continues (e.g., see blocks 303 to 305). If a control command is issued at block 306, the control command is transmitted from the existing vehicle receiver unit 104 to the secondary radio receiver integration unit 101 via the second connection (e.g., wireless/BLUETOOTH connection 105) at block 307. Once received by the secondary radio receiver integration unit 101, a control command mapping/translation process is performed at the secondary radio receiver integration unit 101 at block 308, as described in further detail below, and the mapped control command is then transmitted to the secondary radio receiver unit 102 by the secondary radio receiver integration unit 101 via the first connection (e.g., wired connection 103) at block 309. The control command may be buffered at the secondary radio receiver integration unit 101. Once the mapped control command is received at the secondary radio receiver unit 102, the mapped control command is executed at the secondary radio receiver unit 102 at block 310 to perform a function corresponding to the control command at the secondary radio receiver unit 102, and playback continues at the existing vehicle receiver unit 104.

The secondary radio receiver integration unit 101 acts as an intermediary between the secondary radio receiver unit 102 and the existing vehicle receiver unit 104, allowing the units to communicate with each other even in a vehicle in which direct communication between the units is not possible. As described above, exemplary embodiments of the secondary radio receiver integration unit 101 utilize A2DP and AVRCP to allow the secondary radio receiver integration unit 101 to indirectly link the secondary radio receiver unit 102 and the existing vehicle receiver unit 104 to each other. For example, referring to FIG. 3, A2DP may be utilized when transmitting the audio data from the secondary radio receiver integration unit 101 to the existing vehicle receiver unit 104 once the audio data has been received at the secondary radio receiver integration unit 101 (see blocks 304 and 305). Further, AVRCP may be utilized when transmitting the control command from the existing vehicle receiver unit 104 to the secondary radio receiver integration unit 101 (see block 307), as well as when transmitting the virtual content.

As described above, according to exemplary embodiments, the streaming of the audio data from the secondary radio receiver unit 102 to the existing vehicle receiver unit 104 through the secondary radio receiver integration unit 101 is performed using A2DP. Providing the user with the ability to view, browse and manipulate content generated by the secondary radio receiver unit 102 using the existing vehicle receiver unit 104, and to control the secondary radio receiver unit 102 using the existing vehicle receiver unit 104, is implemented using AVRCP.

The secondary radio receiver integration unit 101, which is directly connected to the secondary radio receiver unit 102 via wired connection 103, is essentially viewed by the secondary radio receiver unit 102 as a typical built-in vehicle receiver unit (e.g., a vehicle head unit). For example, the secondary radio receiver unit 102 is typically designed to be connected to a built-in vehicle receiver unit via, for example, a physical connection such as a DIN connection or other (e.g., proprietary) connection. According to exemplary embodiments of the present invention, rather than being plugged into a typical built-in vehicle receiver unit, the secondary radio receiver unit 102 is instead plugged into the secondary radio receiver integration unit 101 via the data connection interface 207. Thus, the secondary radio receiver unit 102 essentially views the secondary radio receiver integration unit 101 as a built-in vehicle receiver unit, and interacts and communicates with the secondary radio receiver integration unit 101 as it typically would with a built-in vehicle receiver unit. This interaction and communication may be performed using, for example, standardized communication commands or proprietary communication commands defined by the manufacturer of the secondary radio receiver unit 102. The commands may be, for example, universal asynchronous receiver/transmitter (UART) based serial communication commands. An application program interface(s) (API) provided by the manufacturer of the secondary radio receiver unit 102 intended to allow the secondary radio receiver unit 102 to communicate and interact with a built-in vehicle receiver unit may be used to facilitate communication and interaction between the secondary radio receiver unit 102 and the secondary radio receiver integration unit 101.

As the secondary radio receiver integration unit 101 receives commands from the secondary radio receiver unit 102, the secondary radio receiver integration unit 101 translates/maps these commands into a format that is decipherable by the existing vehicle receiver unit 104. For example, the secondary radio receiver integration unit 101 may translate/map these commands into standard AVRCP commands that may be deciphered by the existing vehicle receiver unit 104. A single command in one format may be mapped to a single command in a second format, or a sequence of commands in the second format (e.g., a plurality of commands in one format may be implemented to perform a single command in another format). AVRCP supports BLUETOOTH specific extensions that allow for the transfer of metadata related to content to be transferred between devices. The commands received from the secondary radio receiver unit 102 may correspond to an instruction to display certain content (e.g., visual content corresponding to metadata). Thus, the secondary radio receiver integration unit 101 may be described as receiving visual content generated by the secondary radio receiver unit 102. As a result, any type of content, including visual content generated by the secondary radio receiver unit 104 may be passed on to the existing vehicle receiver unit 104 by the secondary radio receiver integration unit 101 using AVRCP commands. For example, information including, but not limited to, satellite radio channel information (e.g., channel names and numbers), preset information (e.g., favorite channels set by the user), channel categories/directories, artist information, song information, diagnostic information (e.g., information indicating satellite radio antenna problems), etc., all of which is generated by the secondary radio receiver unit 102, may be passed on to and displayed by the existing vehicle receiver unit 104 via the secondary radio receiver integration unit 101. It is to be understood that the types of data/information/visual content described herein are exemplary, and that the secondary radio receiver integration unit 101 allows any type of data/information output by the secondary radio receiver unit 102 to be displayed by the existing vehicle receiver unit 104.

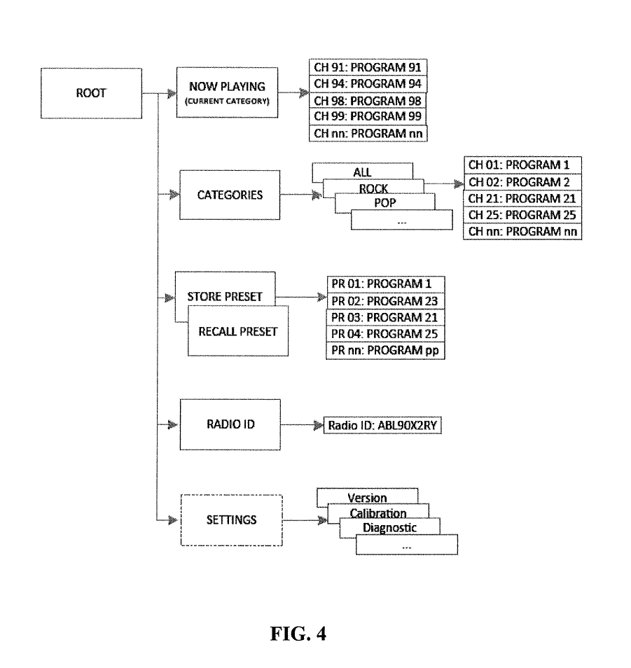

FIG. 4 shows an example of a virtual menu system that may be utilized when mapping data between the secondary radio receiver unit 102 and the existing vehicle receiver unit 104 as described above, according to an exemplary embodiment of the present invention. For example, a virtual menu system may be created using AVRCP folder commands to allow for the implementation of functionality of the secondary radio receiver unit 102 via the existing vehicle receiver unit 104. Virtual folders may be created and utilized by the secondary radio receiver integration unit 101 as the user accesses different functionality (e.g., browsing/viewing categories, presets, radio ID, settings, etc.) of the secondary radio receiver unit 102 via the existing vehicle receiver unit 104. It is to be understood that utilization of the virtual menu system as shown in FIG. 4 is exemplary, and exemplary embodiments of the present invention are not limited to utilizing the virtual menu system when performing mapping.

In addition to facilitating the display of content generated by the secondary radio receiver unit 102 at the existing vehicle receiver unit 104, the secondary radio receiver integration unit 101 also facilitates controlling the secondary radio receiver unit 102 using the existing vehicle receiver unit 104. For example, as described above, a control command may be issued by the existing vehicle receiver unit 104 in response to a user entering input at the existing vehicle receiver unit 104. These control commands may be transmitted from the existing vehicle receiver unit 104 to the secondary radio receiver integration unit 101 via the wireless/BLUETOOTH connection 105. The control commands may be, for example, standard AVRCP control commands. The control commands may correspond to a variety of functions to be performed at the secondary radio receiver unit 102 including, for example, viewing and changing satellite radio channels, viewing and editing preset/favorite information, viewing channel/track/title/artist/song information, etc. As described above, the user may control the secondary radio receiver unit 102 using the input controls of the existing vehicle receiver unit 104 including, for example, physical buttons/knobs (e.g., track up/down, volume up/down, etc.) of the existing vehicle receiver unit 104, a touchscreen of the existing vehicle receiver unit 104, a remote control of the existing vehicle receiver unit 104, etc. Once received at the secondary radio receiver integration unit 101, the control command is translated to a format decipherable by the secondary radio receiver unit 102 (e.g., a standardized or proprietary format, as described above), is transmitted to the secondary radio receiver unit 102 via the wired connection 103, and is executed at the secondary radio receiver unit 102. Facilitating two-way communication between the secondary radio receiver unit 102 and the existing vehicle receiver unit 104 allows the user to both receive information from the secondary radio receiver unit 102 via the existing vehicle receiver unit 104, and control the secondary radio receiver unit 102 using the existing vehicle receiver unit 104.

Translating the commands received from the secondary radio receiver unit 102 to a format decipherable by the existing vehicle receiver unit 104 (e.g., a first format), and translating control commands received from the existing vehicle receiver unit 104 into a format decipherable by the secondary radio receiver unit 102 (e.g., a second format) may be performed in a variety of manners. For example, the secondary radio receiver integration unit 101 may utilize a mapping table that maps commands (e.g., relating to visual data) and control commands in the first format to corresponding commands and control commands in the second format, and vice versa. For example, data in the second format may include a satellite radio channel name/number, artist information, song information, album information, etc. This data may be generated by the secondary radio receiver unit 102, and may be output as commands by the secondary radio receiver unit 102 (e.g., a command to output satellite radio channel name/number, a command to output artist information, etc.) A mapping table may be stored in the storage device 204 of the secondary radio receiver integration unit 101 that maps these commands from the second format (e.g., a proprietary format decipherable by the secondary radio receiver unit 102) to corresponding commands in the first format (e.g., standard AVRCP commands decipherable by the existing vehicle receiver unit 104). Thus, the appropriate information may be displayed at the existing vehicle receiver unit 104).

Similarly, the mapping table may be used to map control commands issued by the existing vehicle receiver unit 104 in the first format to control commands in the second format, allowing the control commands to be deciphered and acted upon by the secondary radio receiver unit 102. For example, many existing vehicle receiver units 104 typically include input controls providing the same or similar functionality. For example, many existing vehicle receiver units 104 include a next/previous track input control, a play/pause input control, etc. Thus, control commands corresponding to these input controls may be mapped from first format (e.g., standard AVRCP commands decipherable by the existing vehicle receiver unit 104) to corresponding control commands in the second format (e.g., a proprietary format decipherable by the secondary radio receiver unit 102). Accordingly, the secondary radio receiver integration unit 101 allows a user to control the secondary radio receiver unit 102 using the input controls (e.g., buttons, knobs, etc.) of the existing vehicle receiver unit 104.

In addition, many existing vehicle receiver units 104 include a display having a touchscreen interface as an input control. In this scenario, the secondary radio receiver integration unit 101 may map commands and control commands to virtual inputs on the display. Virtual inputs may include, for example, virtual buttons, toggles, directories, folders, etc. Existing virtual inputs (e.g., buttons) already present on the existing vehicle receiver unit 104 may be utilized by mapping control commands to these virtual inputs (e.g., virtual buttons). In addition, new virtual inputs (e.g., buttons) may be rendered under control of the secondary radio receiver integration unit 101, providing additional functionality in regards to controlling the secondary radio receiver unit 102. Further, in exemplary embodiments, the secondary radio receiver integration unit 101 may render virtual inputs (e.g., virtual buttons) providing added functionality including, for example, providing the user with a user interface allowing him/her to control other systems within the vehicle including, for example, an additional entertainment system (e.g., a rear seat or overhead entertainment system) coupled to the existing vehicle receiver unit 104. In this embodiment, the user interface may allow the user to display/play multimedia content present on, for example, a memory card, internal/external DVD/BLU-RAY system, etc. connected to the additional entertainment system. Additional exemplary embodiments may render a user interface allowing the user to configure different audio zones within the vehicle. For example, different audio content from different audio sources may be routed to different speakers and headsets within the vehicle using an interface created by the secondary radio receiver integration unit 101 and displayed on the existing vehicle receiver unit 104.

The secondary radio receiver integration unit 101 is treated by the existing vehicle receiver unit 104 as a BLUETOOTH audio source, similar to, for example, a BLUETOOTH connected phone. The user may switch audio sources using the existing vehicle receiver unit 104, allowing the user to toggle between listening to media generated by the secondary radio receiver unit 102, media on a BLUETOOTH connected phone, FM/AM radio, etc. The user initially establishes a BLUETOOTH connection between the existing vehicle receiver unit 104 and the secondary radio receiver integration unit 101 using a BLUETOOTH pairing process normally performed to pair BLUETOOTH devices. The secondary radio receiver integration unit 101 may be paired to the existing vehicle receiver unit 104 at the same time as additional BLUETOOTH devices such as, for example, a smartphone, allowing the user to both listen to the secondary radio receiver unit 102 while using a smartphone for phone call functionality at the same time (e.g., the secondary radio receiver integration unit 101 may be paired to the existing vehicle receiver unit 104 as an audio source at the same time that a smartphone is paired to the existing vehicle receiver unit 104 as a non-audio source).

As described above, according to exemplary embodiments of the present invention, the secondary radio receiver integration unit 101 facilitates two-way communication between the secondary radio receiver unit 102 and the existing vehicle receiver unit 104 by performing a command mapping process corresponding to the commands of the units. For example, in an exemplary embodiment, a set of messages is received at the secondary radio receiver integration unit 101 from the secondary radio receiver unit 102. For example, messages relating to channel information, channel lineups, artist/track/title information, and various other types of information and metadata are received by the secondary radio receiver integration unit 101. The processor 202 in the secondary radio receiver integration unit 101 processes this data/commands, including mapping it to data/commands decipherable by the existing vehicle receiver unit 104 using, for example, existing BLUETOOTH profiles such as A2DP and AVRCP. The processed data is then passed on to the wireless transceiver 208 of the secondary radio receiver integration unit 101, which then transmits this data to the existing vehicle receiver unit 104 via the wireless/BLUETOOTH connection 105.

Exemplary embodiments of the present invention allow for a variety of mapping approaches between the existing vehicle receiver unit 104 and the secondary radio receiver unit 102. For example, the artist/album/title fields of the existing vehicle receiver unit 104 may be utilized to show, for example, the channel name, category name, or any other arbitrary visual content (e.g., text information) generated by the secondary radio receiver unit 102 in conjunction with or instead of the normally displayed artist/album/title information. In an exemplary embodiment, a field may display a certain piece of information for a predefined period of time (e.g., 3 seconds), and then be updated with other information generated by the secondary radio receiver unit 102 including, for example, channel name, category name, etc. Fields may also include combinations of information generated by the secondary radio receiver unit 102. For example, a single field may include a concatenated string of different types of information (e.g., artist*album) generated by the secondary radio receiver unit 102.

As described above, according to exemplary embodiments of the present invention, the secondary radio receiver integration unit 101 may provide extended control capabilities relating to the secondary radio receiver unit 102. For example, the user may browse and edit preset channel listings (e.g., favorite channels), browse category (e.g., genre) listings, perform searches with or without utilizing filters, receive diagnostic and advisory messages (e.g., messages relating to a weak or broken connection, subscription information including, e.g., advising the user that he/she is not subscribed to certain channels, billing information from the satellite radio provider, etc.). In addition, if the secondary radio receiver unit 102 includes play/pause/rewind/fast forward/save/delete functionality, this functionality may be controlled via the existing vehicle receiver unit 104 as well.

According to exemplary embodiments of the present invention, utilization of A2DP together with AVRCP allows for both basic audio streaming from the secondary radio receiver unit 102 to the existing vehicle receiver unit 104, as well as for giving the user the ability to control the secondary radio receiver unit 102 from the existing vehicle receiver unit 104, as described above. According to exemplary embodiments, A2DP may be utilized without AVRCP 1.4 to allow for basic audio streaming without extended control capabilities, or AVRCP may be utilized without A2DP to allow for a device to be controlled without streaming audio to the controlling device (e.g., to allow for the secondary radio receiver unit 102 to be controlled by the existing vehicle receiver unit 104 while streaming audio to a set of wireless headphones). For example, in an exemplary embodiment, an additional BLUETOOTH device (e.g., a smartphone, tablet computer, etc.) may be connected to the secondary radio receiver unit 102 via the secondary radio receiver integration unit 101 together with the existing vehicle receiver unit 104. The additional BLUETOOTH device may utilize AVRCP 1.4 to function as a controller that controls the secondary radio receiver unit 102 to provide extended control capabilities (e.g., audio may be played on the existing vehicle receiver unit 104 while simultaneously controlling the secondary radio receiver unit 102 with the additional BLUETOOTH device). The additional BLUETOOTH device may also be utilized in embodiments in which the vehicle supports AVRCP 1.4, allowing the user to control the secondary radio receiver unit 102 using both the existing vehicle receiver unit 104 and/or the additional BLUETOOTH device.

According to an exemplary embodiment of the present invention, the secondary radio receiver unit 102 may be built into the secondary radio receiver integration unit 101.

Exemplary embodiments of the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

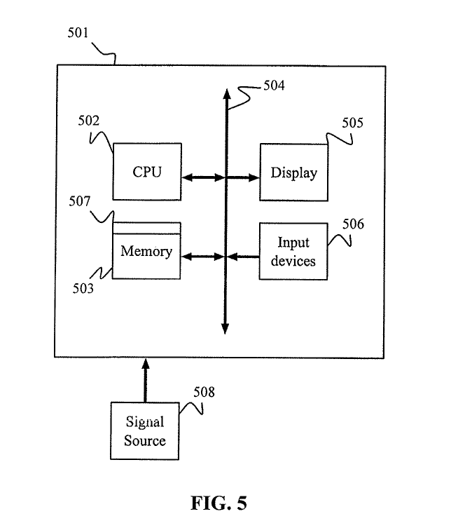

FIG. 5 illustrates a computer system for implementing aspects of exemplary embodiments of the present invention.

Referring to FIG. 5, exemplary embodiments of the present invention may utilize a computer system 501 that includes, inter alia, a central processing unit (CPU) 502, a memory 503 and an input/output (I/O) interface 504. The computer system 501 is generally coupled through the I/O interface 504 to a display 505 and various input devices 506. The support circuits can include circuits such as cache, power supplies, clock circuits, and a communications bus. The memory 503 can include random access memory (RAM), read only memory (ROM), disk drive, tape drive, or a combination thereof. Exemplary embodiments may be implemented as a routine 507 that is stored in memory 503 and executed by the CPU 502 to process the signal from the signal source 505. As such, the computer system 501 is a general-purpose computer system that becomes a specific-purpose computer system when executing the routine 507 of the present invention.

While the present invention has been particularly shown and described with reference to the exemplary embodiments thereof, it will be understood by those of ordinary skill in the art that various changes in form and detail may be made therein without departing from the spirit and scope of the present invention as defined by the

What is claimed is:

1. A method of integrating secondary radio functionality in a vehicle, comprising:
establishing a wired connection between a secondary radio receiver integration unit and a secondary radio receiver unit;
establishing a wireless connection between the secondary radio receiver integration unit and a vehicle receiver unit mounted in the vehicle;
transmitting audio data from the secondary radio receiver unit to the secondary radio receiver integration unit via the wired connection; and
transmitting the audio data from the secondary radio receiver integration unit to the vehicle receiver unit via a wireless connection,
wherein the audio data is played via a speaker connected to the vehicle receiver unit.

2. The method of claim 1, further comprising:
receiving visual content generated by the secondary radio receiver unit at the secondary radio receiver integration unit via the wired connection; and
transmitting the visual content from the secondary radio receiver integration unit to the vehicle receiver unit via the wireless connection,
wherein the visual content is displayed via a display connected to the vehicle receiver unit.

3. The method of claim 2, wherein the display is built into the vehicle receiver unit.

4. The method of claim 2, further comprising:
receiving a control command at the secondary radio receiver integration unit via the wireless connection, wherein the control command is issued by the vehicle receiver unit in response to a user interacting with the vehicle receiver unit; and
transmitting the control command from the secondary radio receiver integration unit to the secondary radio receiver unit via the wired connection,
wherein the control command is executed at the secondary radio receiver unit to perform a function corresponding to the control command at the secondary radio receiver unit.

5. The method of claim 4, wherein the visual content is mapped, by the secondary radio receiver integration unit, from a first format decipherable by the secondary radio receiver unit to a second format that is different from the first format and is decipherable by the vehicle receiver unit, and the visual content is transmitted from the secondary radio receiver integration unit to the vehicle receiver unit in the second format.

6. The method of claim 5, wherein the wireless connection is a BLUETOOTH connection, the audio data is transmitted using an Advanced Audio Distribution Profile (A2DP) BLUETOOTH profile, and the visual content is mapped using an Audio/Video Remote Control Profile (AVRCP) BLUETOOTH profile.

7. The method of claim 6, wherein the AVRCP BLUETOOTH profile is version 1.4 or higher.

8. The method of claim 4, wherein the control command is mapped, by the secondary radio receiver integration unit, from a first format decipherable by the vehicle receiver unit to a second format that is different from the first format and is decipherable by the secondary radio receiver unit, and the control command is relayed from the secondary radio receiver integration unit to the secondary radio receiver unit in the second format.

9. The method of claim 8, wherein the wireless connection is a BLUETOOTH connection, the audio data is transmitted using an Advanced Audio Distribution Profile (A2DP) BLUETOOTH profile, and the control command is mapped using an Audio/Video Remote Control Profile (AVRCP) BLUETOOTH profile.

10. The method of claim 9, wherein the AVRCP BLUETOOTH profile is version 1.4 or higher.

11. The method of claim 1, wherein the vehicle receiver unit is non-removably mounted in the vehicle.

12. The method of claim 11, wherein the vehicle receiver unit is non-removably mounted in a dashboard of the vehicle.

13. A method of integrating satellite radio functionality in a vehicle, comprising:
establishing a wired connection between a satellite radio receiver integration unit and an aftermarket satellite radio receiver unit;
establishing a BLUETOOTH connection between the satellite radio receiver integration unit and a vehicle receiver unit non-removably mounted in the vehicle,
wherein the aftermarket satellite radio receiver unit and the vehicle receiver unit are not directly connected to each other;
transmitting audio data from the aftermarket satellite radio receiver unit to the satellite radio receiver integration unit via the wired connection; and
transmitting the audio data from the satellite radio receiver integration unit to the vehicle receiver unit via the BLUETOOTH connection,
wherein the audio data is played via a speaker connected to the vehicle receiver unit.

14. A secondary radio receiver integration unit, comprising:
a processor configured to process audio data;
a data connection interface configured to connect the secondary radio receiver integration unit to an secondary radio receiver unit via a wired connection; and
a wireless transceiver configured to connect the secondary radio receiver integration unit to a vehicle receiver unit mounted in the vehicle via a wireless connection,
wherein the data connection interface is configured to transmit the audio data from the secondary radio receiver unit to the secondary radio receiver integration unit, and the wireless transceiver is configured to transmit the audio data from the secondary radio receiver integration unit to the vehicle receiver unit to be played via a speaker connected to the vehicle receiver unit.

15. The secondary radio receiver integration unit of claim 14, wherein the data connection interface is further configured to receive visual content generated by the secondary radio receiver unit, and the wireless transceiver is further configured to transmit the visual content from the secondary radio receiver integration unit to the vehicle receiver unit to be displayed via a display connected to the vehicle receiver unit.

16. The secondary radio receiver integration unit of claim 15, wherein the display is built into the vehicle receiver unit.

17. The secondary radio receiver integration unit of claim 15,
wherein the wireless transceiver is a BLUETOOTH transceiver, the BLUETOOTH transceiver is configured to receive a control command issued by the vehicle receiver unit in response to a user interacting with the vehicle receiver unit, and the data connection interface is configured to transmit the control command from the secondary radio receiver integration unit to the secondary radio receiver unit to execute the control command at the secondary radio receiver unit to perform a function corresponding to the control command at the secondary radio receiver unit,
wherein the processor is configured to map the visual content from a first format decipherable by the secondary radio receiver unit to a second format that is different from the first format and is decipherable by the vehicle receiver unit, and the visual content is relayed from the secondary radio receiver integration unit to the vehicle receiver unit in the second format,
wherein the audio data is transmitted using an Advanced Audio Distribution Profile (A2DP) BLUETOOTH profile, and the visual content is mapped using an Audio/Video Remote Control Profile (AVRCP) BLUETOOTH profile.

18. The secondary radio receiver integration unit of claim 15,
wherein the wireless transceiver is a BLUETOOTH transceiver, the BLUETOOTH transceiver is configured to receive a control command issued by the vehicle receiver unit in response to a user interacting with the vehicle receiver unit, and the data connection interface is configured to transmit the control command from the secondary radio receiver integration unit to the secondary radio receiver unit to execute the control command at the secondary radio receiver unit to perform a function corresponding to the control command at the secondary radio receiver unit,
wherein the processor is configured to map the control command from a first format decipherable by the vehicle receiver unit to a second format that is different from the first format and is decipherable by the secondary radio receiver unit, and the control command is transmitted from the secondary radio receiver integration unit to the secondary radio receiver unit in the second format,
wherein the audio data is transmitted and relayed using an Advanced Audio Distribution Profile (A2DP) BLUETOOTH profile, and the control command is mapped using an Audio/Video Remote Control Profile (AVRCP) BLUETOOTH profile.

19. The secondary radio receiver integration unit of claim 14, wherein the secondary radio receiver unit is an aftermarket satellite radio receiver unit and the secondary radio receiver integration unit is a satellite radio receiver integration unit.

20. The secondary radio receiver integration unit of claim 14, wherein the vehicle receiver unit is non-removably mounted in a dashboard of the vehicle.
